(19) United States
(12) Patent Application Publication
(10) Pub. No.: US 2025/0379284 A1
(43) Pub. Date: Dec. 11, 2025

(54) DECOUPLED SUPERBEAM DESIGN FOR MANUFACTURABILITY

(71) Applicant: GM GLOBAL TECHNOLOGY OPERATIONS LLC, Detroit, MI (US)

(72) Inventors: Lu HUANG, Troy, MI (US); Hui-ping WANG, Troy, MI (US); Joshua Lee SOLOMON, Berkley, MI (US); Yunzhi Xu, Troy, MI (US); Alexander M. BILINSKI, Avoca, MI (US); Philip Daniel HAMELIN, Clarkston, MI (US)

(21) Appl. No.: 18/739,840

(22) Filed: Jun. 11, 2024

(51) Int. Cl. H01M 10/6555; H01M 10/613; H01M 10/647; H01M 10/656; H01M 50/209; H01M 50/291

(52) U.S. Cl. CPC H01M 10/6555; H01M 10/613; H01M 10/647; H01M 10/656; H01M 50/209; H01M 50/291

(57) ABSTRACT

A rechargeable energy storage system includes a housing including a tray and a sidewall structure. A plurality of beam assemblies extends in parallel across the housing. The plurality of beam assemblies each include a first face plate and a second face plate. The first face plate includes an elongated body having an upper flange extending generally perpendicular to an upper end of the elongated face body. The second face plate includes an elongated body having a lower flange extending generally perpendicular to a lower end of the elongated face body. A pair of coolant plates are sandwiched between the first face plate and the second face plate.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a cooling beam design for battery cell assemblies.

Ribbons are commonly utilized in cylindrical cell battery assemblies to facilitate cell cooling. However, there are several existing issues with the ribbons. First, they lack structural rigidity. Second, they require attachment to the cell walls during assembly as they cannot stand independently. Third, due to the predefined positions of cells by the cell holders during assembly, the ribbons do not establish tight contact on both sides with the cells, potentially compromising cooling performance.

### SUMMARY

According to an aspect of the present disclosure, a rechargeable energy storage system includes a housing including a tray and a sidewall structure. A plurality of beam assemblies extend in parallel across the housing. The plurality of beam assemblies each include a first face plate and a second face plate. The first face plate includes an elongated body having an upper flange extending generally perpendicular to an upper end of the elongated face body. The second face plate includes an elongated body having a lower flange extending generally perpendicular to a lower end of the elongated face body. A pair of coolant plates are sandwiched between the first face plate and the second face plate, where the coolant plate next to the first face plate is brazed or welded to the first face plate to form a cold plate, and the coolant plate next to the second face plate is brazed or welded to the second face plate to form another cold plate. The pair of cold plates are connected to a coolant source. A plurality of battery cells disposed in the housing and in contact with the face plates of adjacent beam assemblies.

According to a further aspect, the first face plate further includes a hook shaped lower flange extending from an inboard side of a lower end of the elongated face body.

According to a further aspect, the hook shaped lower flange of the first face plate is connected to the inboard side of a lower end of the elongated face body of the second face plate.

According to a further aspect, the second face plate includes a hook shaped upper flange extending from an inboard side of an upper end of the elongated face body.

According to a further aspect, the hook shaped upper flange of the second face plate is connected to the inboard side of an upper end of the elongated face body of the first face plate.

According to a further aspect, the first face plate further includes a lower flange extending from an inboard side of a lower end of the elongated face body.

According to a further aspect, the lower flange of the first plate is connected to the lower flange of the second face plate.

According to a further aspect, the second face plate further includes an upper flange extending from an inboard side of an upper end of the elongated face body.

According to a further aspect, the lower flange of the second face plate is connected to the tray.

According to a further aspect, the tray includes a plurality of elongated protruding ribs that extend a length of the tray, wherein the plurality of protruding ribs include a pair of sidewalls and a top surface with a step therein.

According to a further aspect, the lower flange of the second face plate of the plurality of beam assemblies are connected to the top surface of the plurality of elongated protruding ribs adjacent to the step.

According to a further aspect, the plurality of battery cells are supported on top of the lower flange of one of the beam assemblies and on top of the step of an adjacent one of the plurality of elongated protruding ribs.

According to a further aspect, the tray includes a bent side flange that is connected to the sidewall.

According to a further aspect, each of the first face plate and the second face plate include an inlet coolant connector and an outlet coolant connector in communication with each of the pair of cold plates.

According to a further aspect, the pair of coolant passage plates include a serpentine coolant passage that extends from the inlet coolant connector to the outlet coolant connector.

According to a further aspect, the inlet coolant connectors and the outlet coolant connectors of each beam assembly are connected to a coolant source.

According to a further aspect, the first face plate includes a top cap including a first horizontal portion extending generally perpendicular to an outboard side of an upper end of the elongated face body, a vertically extending portion extending from the first horizontal portion and the upper flange of the first face plate extends horizontally from a top of the vertically extending portion.

According to another aspect, a rechargeable energy storage system includes a housing including a plurality of trays. A plurality of beam assemblies extend in parallel across the housing. The plurality of beam assemblies each include a first face plate and a second face plate. The first face plate includes an elongated body having an upper flange extending generally perpendicular to an upper end of the elongated face body. The second face plate includes an elongated body having a lower flange extending generally perpendicular to a lower end of the elongated face body. A pair of coolant plates are sandwiched between the first face plate and the second face plate, where the coolant plate next to the first face plate is brazed or welded to the first face plate to form a cold plate, and the coolant plate next to the second face plate is brazed or welded to the second face plate to form another cold plate. The pair of cold plates are connected to a coolant source. A plurality of battery cells are disposed in the housing and in contact with the plates of adjacent beam assemblies. A first end beam assembly on one of the plurality trays and a second end beam assembly on an adjacent one of the plurality of trays, the first end beam being interconnected to the second end beam assembly for coolant flow, wherein the first and second end beam assemblies each include a first face plate and a second face plate joined to the first face plate and a pair of coolant plates disposed between the first face plate and the second face plate.

According to a further aspect, the first end beam includes a first protruding top cap and the second end beam includes a second protruding top cap that is connected to the first protruding top cap of the first end beam.

According to another aspect, a rechargeable energy storage system includes a housing including a plurality of trays. A plurality of beam assemblies extend in parallel across the housing. The plurality of beam assemblies each include a first face plate and a second face plate. The first face plate includes an elongated body having an upper flange extending generally perpendicular to an upper end of the elongated face body. The second face plate includes an elongated body having a lower flange extending generally perpendicular to a lower end of the elongated face body, a pair of coolant plates are sandwiched between the first face plate and the second face plate, where the coolant plate next to the first face plate is brazed or welded to the first face plate to form a cold plate, and the coolant plate next to the second face plate is brazed or welded to the second face plate to form another cold plate. The pair of cold plates are connected to a coolant source. A plurality of battery cells disposed in the housing and in contact with the plates of adjacent beam assemblies. An end beam assembly disposed between adjacent ones of the plurality of trays. The end beam assembly includes a sheet metal structure having a box shaped cross-section. A pair of face plates are secured to opposite sides of the sheet metal structure and a pair of coolant plates are disposed on an inboard face of the pair of face plates.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a portion of a battery cell assembly with beams being battery separators according to the principles of the present disclosure;

FIG. 2 is a perspective view of a cooling beam assembly according to a first embodiment;

FIG. 3 is a cross-sectional view of the cooling beam assembly of FIG. 2;

FIG. 4 is an exploded perspective view of the cooling beam assembly of FIG. 2;

FIG. 5 is a perspective view of a cooling beam assembly according to a second embodiment;

FIG. 6 is a cross-sectional view of the cooling beam assembly of FIG. 5;

FIG. 7 is a perspective view of a corrugated bottom plate according to the principles of the present disclosure;

FIG. 8 is a cross-sectional view taken in a longitudinal direction along the corrugated bottom plate;

FIG. 9 is a cross-sectional view taken in a lateral direction along the corrugated bottom plate;

FIG. 10 is a cross-sectional view showing the connection of the cooling beam assembly to the corrugated bottom plate;

FIG. 11 is a cross-sectional view showing the connection of the corrugated bottom plate to the end beam;

FIG. 12 is a cross-sectional view showing the cooling beam assemblies with a built-in top cap connected to a corrugated top sheet according to an aspect of the present disclosure;

FIG. 13 is a schematic view of an end beam design of the battery cell assembly according to a first embodiment;

FIGS. 14 and 15 are cross-sectional views of an end beam design according to a second embodiment; and

FIG. 16 is a cross-sectional view of an end beam design according to a third embodiment.

In the drawings, reference numbers may be reused to identify similar and/or identical elements.

### DETAILED DESCRIPTION

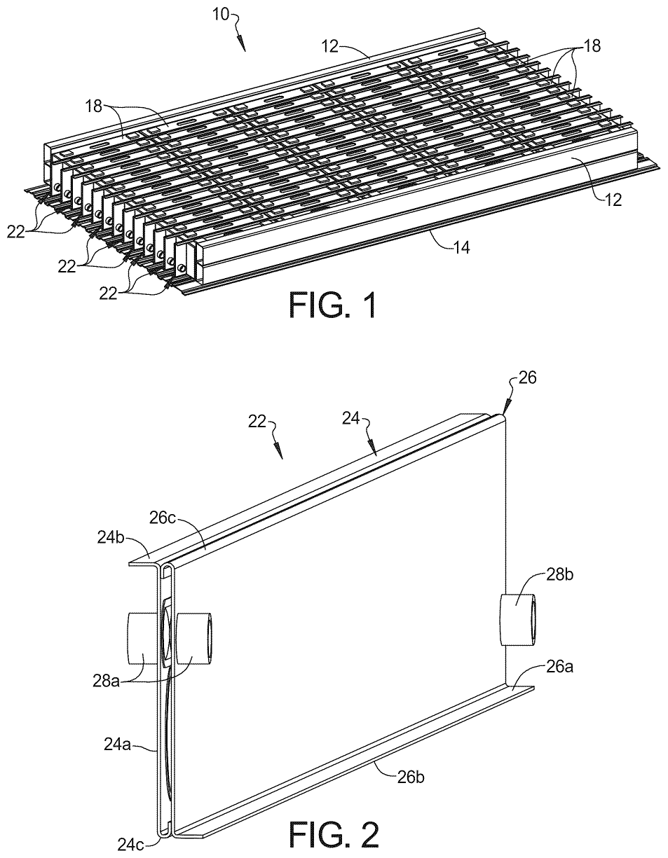

With reference to FIG. 1, a portion of a rechargeable energy storage system 10 is shown including a wall structure 12 (part of which is shown) surrounding a tray 14 on which a plurality of battery cells 18 are aligned. The battery cells 18 are aligned in a plurality of rows that are each separated by a beam assembly 22 according to the principles of the present disclosure.

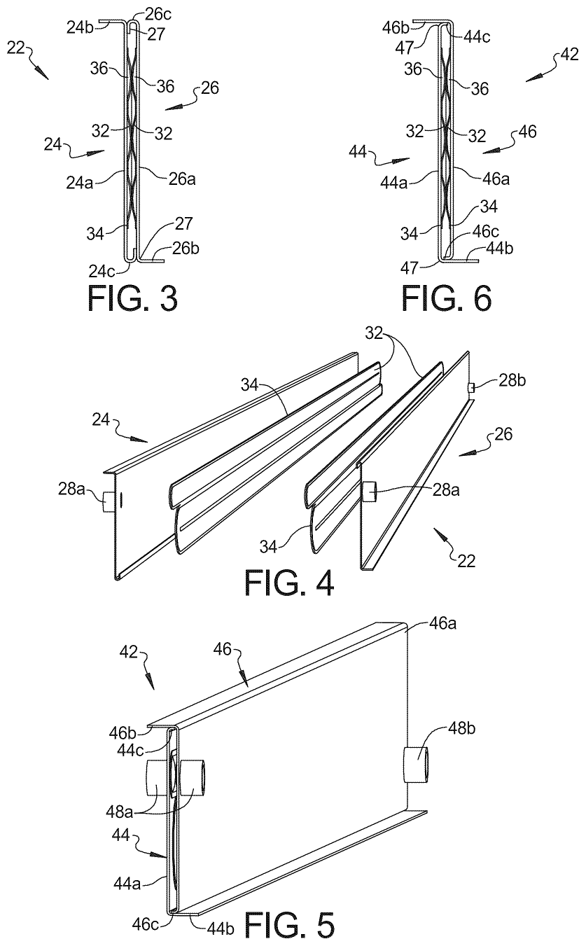

With reference to FIGS. 2-4, a first embodiment of the beam assembly 22 includes a first face plate 24 including an elongated flat face body 24a having an upper flange 24b extending generally perpendicular to an outboard side of an upper end of the elongated flat face body 24a. The first face plate 24 further includes a hook shaped lower flange 24c extending from an inboard side of a lower end of the elongated flat face body 24a. The beam assembly 22 further includes a second face plate 26 including an elongated flat face body 26a having a lower flange 26b extending generally perpendicular to an outboard side of a lower end of the elongated flat face body 26a. The second face plate 26 further includes a hook shaped upper flange 26c extending from an inboard side of an upper end of the elongated flat face body 26a. The hook shaped lower flange 24c of the first face plate 24 is connected to the inboard side of a lower end of the elongated flat face body 26a of the second face plate 26 by brazing 27 or other attachment technique and the hook shaped upper flange 26c of the second face plate 26 is connected to the inboard side of an upper end of the elongated flat face body 24a of the first face plate 24 by brazing 27 or other attachment technique.

The first face plate 24 and the second face plate 26 each include an inlet coolant connector 28a and an outlet coolant connector 28b on the outboard side thereof and the coolant connectors 28a, 28b are each in communication with apertures through the first and second face plates 24, 26. A pair of coolant plates 32 are disposed on an inboard face of a respective one of the first and second face plates 24, 26 and are sealed around a perimeter 34 and along separation lines thereof to define a serpentine coolant passage 36 (best seen in FIG. 4) along the inboard side of the first and second face plates 24, 26. The serpentine coolant passage 36 extends from the inlet coolant connector 28a along the surface of the first and second face plates 24, 26 in a serpentine or desired pattern and to the outlet coolant connector 28b.

With reference to FIGS. 5 and 6, a second embodiment of the beam assembly 42 includes a first face plate 44 including an elongated flat face body 44a having a lower flange 44b extending generally perpendicular to an inboard side of a lower end of the elongated flat face body 44a. The first face plate 44 further includes a hook shaped upper flange 44c extending from the inboard side of the upper end of the elongated flat face body 44a. The beam assembly 22 further includes a second face plate 46 including an elongated flat face body 46a having an upper flange 46b extending generally perpendicular to an inboard side of an upper end of the elongated flat face body 46a. The second face plate 46 further includes a lower flange 46c extending from the inboard side of a lower end of the elongated flat face body 46a. The upper flange 44c of the first face plate 44 is connected to a bottom side of the upper flange 46b of the second face plate 46 by brazing 47 or other attachment technique and the lower flange 46c of the second face plate 46 is connected to a top side of the lower flange 44b of the first face plate 44 by brazing 47 or other attachment technique.

The first face plate 44 and the second face plate 46 each include an inlet coolant connector 48a and an outlet coolant connector 48b on the first side (outer face) thereof and the coolant connectors 48a, 48b are each in communication with apertures through the first and second face plates 44, 46. A pair of coolant plates 32 are disposed on an inboard face of a respective one of the first and second face plates 44, 46 and are sealed around a perimeter 34 thereof to define a serpentine coolant passage 36 (best seen in FIG. 6) along the inboard side of the first and second face plates 44, 46. The serpentine coolant passage 36 extends from the inlet coolant connector 48a along the surface of the first and second face plates 44, 46 in a serpentine or desired pattern and to the outlet coolant connector 48b.

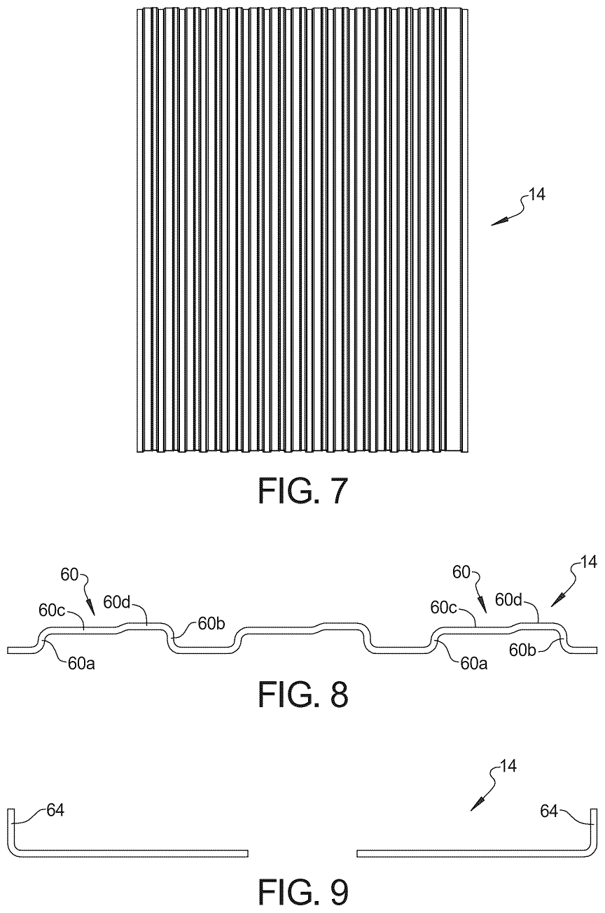

With reference to FIGS. 7-11, the tray 14 is shown and includes a corrugated cross-section as shown in FIG. 8. The corrugated cross section of the tray 14 includes a plurality of elongated protruding ribs 60 that extend a length of the tray 14. The number of elongated protruding ribs is equal to a number of rows of battery cells/modules. The protruding ribs 60 are stamped into the tray 14 and include a pair of sidewalls 60a, 60b and a top surface 60c with a step 60d therein. The step 60d has an increased height relative to a remainder of the top surface that is approximately equal to a thickness of the lower flanges 26b, 44b of the beams 22, 42.

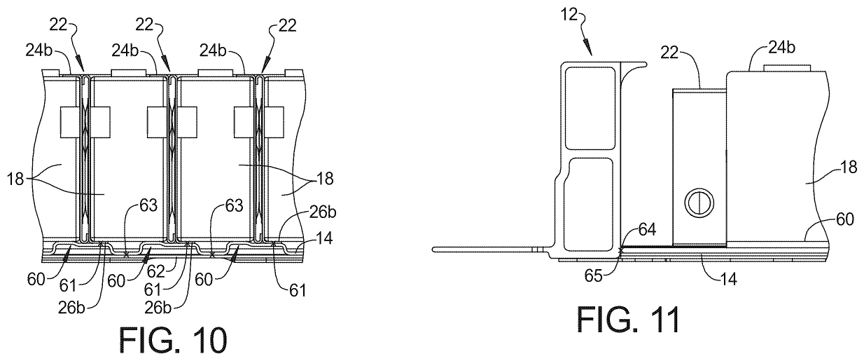

With reference to FIG. 10, a cross-sectional view of a portion of the rechargeable energy storage system 10 is shown including the beam assemblies 22 secured to the tray 14 by welding 61 or brazing the lower flange 26b to the top surface 60c of the protruding ribs 60 adjacent to the step 60d. It is noted that the cross-section of the tray in FIG. 8 is taken in the opposite direction of the cross-section shown in FIG. 10. The battery cells or modules 18 are mounted along the protruding ribs 60 and above the lower flange 26b on one side thereof and below the upper flange 24b of an adjacent beam assembly 22. Accordingly, the battery cells 18 are held securely by the adjacent beam assemblies 22. As shown in FIG. 10, the tray 14 can be secured to a shear plate 62 by welding 63, brazing, adhesive or other known attachment technique.

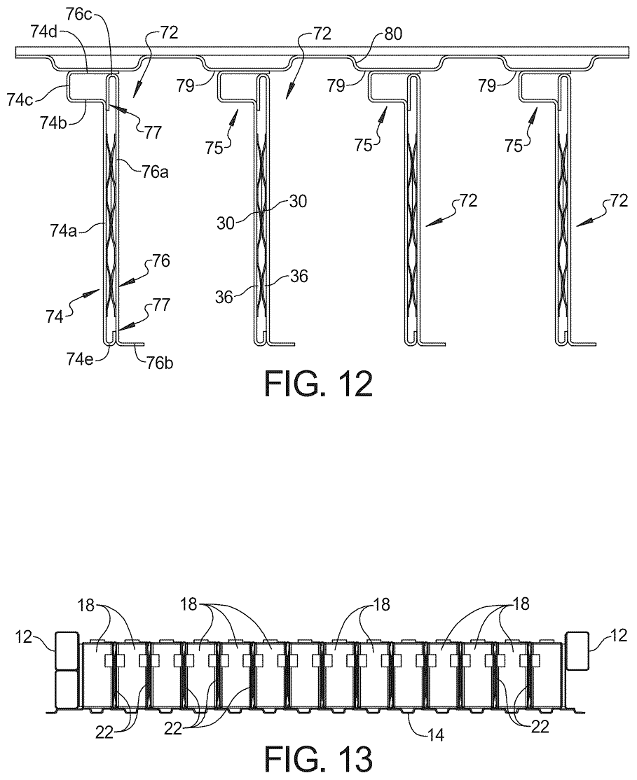

With reference to FIG. 12, a third embodiment of the beam assembly 72 includes a first face plate 74 including an elongated flat face body 74a having a built-in top cap 75 including a first horizontal portion 74b extending generally perpendicular to an outboard side of an upper end of the elongated flat face body 74a, a vertically extending portion 74c extending from the first horizontal portion 74b and a horizontally extending top portion 74d extending from a top of the vertically extending portion 74c. The first face plate 74 further includes a hook shaped lower flange 74e extending from an inboard side of a lower end of the elongated flat face body 74a. The beam assembly 72 further includes a second face plate 76 including an elongated flat face body 76a having a lower flange 76b extending generally perpendicular to an outboard side of a lower end of the elongated flat face body 76a. The second face plate 76 further includes a hook shaped upper flange 76c extending from an inboard side of an upper end of the elongated flat face body 76a. The hook shaped lower flange 74c of the first face plate 74 is connected to the inboard side of a lower end of the elongated flat face body 76a of the second face plate 76 by brazing 77 or other attachment technique and the hook shaped upper flange 76c of the second face plate 76 is connected to the inboard side of an upper end of the elongated flat face body 74a of the first face plate 74 by brazing 77 or other attachment technique. The top cap 75 can be connected to a protruding rib 79 of a corrugated top sheet 80. The horizontally extending top portion 74d of the top cap 75 can be connected to the corrugated top sheet by laser welding, an adhesive or other known connection technique.

The first face plate 74 and the second face plate 76 each include an inlet coolant connector and an outlet coolant connector on the outboard side thereof and the coolant connectors are each in communication with apertures through the first and second face plates 74, 76. A pair of coolant plates 30 as previously described with reference to FIGS. 2-4, are disposed on an inboard face of a respective one of the first and second face plates 74, 76 and are sealed around a perimeter thereof to define a serpentine coolant passage 36 along the inboard side of the first and second face plates 74, 76. The serpentine coolant passage 36 extends from an inlet coolant connector along the surface of the first and second face plates 74, 76 in a serpentine or desired pattern and to the outlet coolant connector.

With reference to FIG. 11, a sidewall 12 can be connected to a side flange 64 of the tray 14 by welding 65, brazing, adhesive or other known attachment technique.

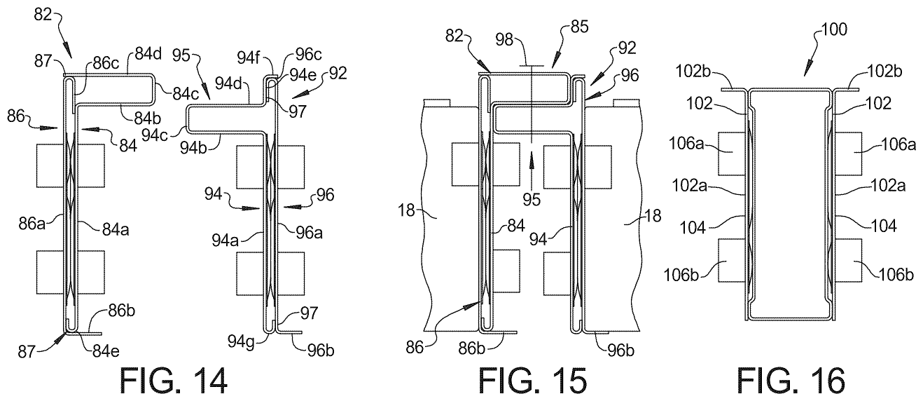

With reference to FIGS. 14 and 15, a P-shaped end beam assembly 82 is provided that can be provided along an end row of battery cells. The end beam assembly 82 includes a first face plate 84 including an elongated flat face body 84a having a built-in top cap 85 including a first horizontal portion 84b extending generally perpendicular to an outboard side of an upper end of the elongated flat face body 84a, a vertically extending portion 84c extending from the first horizontal portion 84b and a horizontally extending top portion 84d extending from a top of the vertically extending portion 84c. The first face plate 84 further includes a hook shaped lower flange 84e extending from an inboard side of a lower end of the elongated flat face body 84a. The end beam assembly 82 further includes a second face plate 86 including an elongated flat face body 86a having a lower flange 86b extending generally perpendicular to an inboard side of a lower end of the elongated flat face body 86a. The second face plate 86 further includes a hook shaped upper flange 86c extending from an inboard side of an upper end of the elongated flat face body 86a. The hook shaped lower flange 84e of the first face plate 84 is connected to the inboard side of a lower end of the elongated flat face body 86a of the second face plate 86 by brazing 87 or other attachment technique and the hook shaped upper flange 86c of the second face plate 86 is connected to the inboard side of an upper end of the elongated flat face body 84a of the first face plate 84 by brazing 87 or other attachment technique.

With continued reference to FIGS. 14 and 15, a mating P-shaped end beam assembly 92 is provided that can be provided along an end row of battery cells and can be interconnected to the P-shaped end beam assembly 82, as illustrated in FIG. 15. The end beam assembly 92 includes a first face plate 94 including an elongated flat face body 94a having a built-in top cap 95 that is disposed below the top cap 85 of the end beam assembly 82, as shown in FIG. 15. The built-in top cap 95 includes a first horizontal portion 94b extending generally perpendicular to an outboard side of an upper end of the elongated flat face body 94a, a first vertically extending portion 94c extending from the first horizontal portion 94b, a second horizontally extending top portion 94d extending from a top of the of the first vertically extending portion 94c, a second vertically extending portion 94e extending from the second horizontally extending portion 94c and a top horizontal flange 94f extends from the second vertically extending portion 94e. The first face plate 94 further includes a hook shaped lower flange 94g extending from an inboard side of a lower end of the elongated flat face body 94a. The end beam assembly 92 further includes a second face plate 96 including an elongated flat face body 96a having a lower flange 96b extending generally perpendicular to an outboard side of a lower end of the elongated flat face body 96a. The second face plate 96 further includes a hook shaped upper flange 96c extending from an inboard side of an upper end of the elongated flat face body 96a. The hook shaped lower flange 94c of the first face plate 94 is connected to the inboard side of a lower end of the elongated flat face body 96a of the second face plate 96 by brazing 97 or other attachment technique and the hook shaped upper flange 96c of the second face plate 96 is connected to the inboard side of the second vertically extending portion 94e and to the top horizontal flange 94f of the first face plate 94 by brazing 97 or other attachment technique.

As shown in FIG. 15, the top cap 85 of the end beam assembly 82 can be connected to the top cap 95 of the end beam assembly 92 by a pin 98 or by another connection technique.

The first face plate 84 and the second face plate 86 of the end beam assembly 82 and the first face plate 94 and the second face plate 96 of the end beam assembly 92 each include an inlet coolant connector 88a and an outlet coolant connector 88b on the outboard side thereof and the coolant connectors 88a, 88b are each in communication with apertures through the first and second face plates 84, 86 and 94, 96. A pair of coolant plates as previously described with reference to FIGS. 2-4, can be disposed on an inboard face of a respective one of the first and second face plates 84, 86 and 94, 96 and are sealed around a perimeter thereof to define a serpentine coolant passage along the inboard side of the first and second face plates 84, 86 and 94, 96. The serpentine coolant passage 36 extends from an inlet coolant connector 88a along the surface of the first and second face plates 84, 86 and 94, 96 in a serpentine or desired pattern and to the outlet coolant connector 88b.

As an alternative as shown in FIG. 16, the end beam 100 can be formed as a rectangular box shape and can include a pair of face plates 102 connected on opposite sides. The face plate 102 includes an elongated flat face body 102a and an upper flange 102b that extends from an upper end of the elongated flat face body 102a. Each of the face plates 102 include a coolant plate 104 disposed between the face plate 102 and the end beam 100. The coolant plate 104 as previously described with reference to FIGS. 2-4, is disposed on an inboard face of the pair of face plates 102 and are sealed around a perimeter thereof to define a serpentine coolant passage along the inboard side of the pair of face plates 102. The serpentine coolant passage extends from an inlet coolant connector 106a along the surface of the pair of face plates 102 in a serpentine or desired pattern and to the outlet coolant connector 106b.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A rechargeable energy storage system comprising:
a housing including a tray and a sidewall structure;
a plurality of beam assemblies extending in parallel across the housing, the plurality of beam assemblies each including a first face plate and a second face plate, the first face plate includes an elongated body having an upper flange extending generally perpendicular to an upper end of the elongated face body, the second face plate includes an elongated body having a lower flange extending generally perpendicular to a lower end of the elongated face body, a pair of coolant plates are sandwiched between the first face plate and the second face plate, where the coolant plate next to the first face plate is brazed or welded to the first face plate to form a cold plate, and the coolant plate next to the second face plate is brazed or welded to the second face plate to form another cold plate, the pair of cold plates are connected to a coolant source; and
a plurality of battery cells disposed in the housing and in contact with the plates of adjacent beam assemblies.

2. The rechargeable energy storage system according to claim 1, wherein the first face plate further includes a hook shaped lower flange extending from an inboard side of a lower end of the elongated face body.

3. The rechargeable energy storage system according to claim 2, wherein the hook shaped lower flange of the first face plate is connected to the inboard side of a lower end of the elongated face body of the second face plate.

4. The rechargeable energy storage system according to claim 2, wherein the second face plate includes a hook shaped upper flange extending from an inboard side of an upper end of the elongated face body.

5. The rechargeable energy storage system according to claim 4, wherein the hook shaped upper flange of the second face plate is connected to the inboard side of an upper end of the elongated face body of the first face plate.

6. The rechargeable energy storage system according to claim 1, wherein the first face plate further includes a lower flange extending from an inboard side of a lower end of the elongated face body.

7. The rechargeable energy storage system according to claim 1, wherein the lower flange of the first plate is connected to the lower flange of the second face plate.

8. The rechargeable energy storage system according to claim 1, wherein the second face plate further includes an upper flange extending from an inboard side of an upper end of the elongated face body.

9. The rechargeable energy storage system according to claim 1, wherein the lower flange of the second face plate is connected to the tray.

10. The rechargeable energy storage system according to claim 9, wherein the tray includes a plurality of elongated protruding ribs that extend a length of the tray, wherein the plurality of protruding ribs include a pair of sidewalls and a top surface with a step therein.

11. The rechargeable energy storage system according to claim 10, wherein the lower flange of the second face plate of the plurality of beam assemblies are connected to top surface of the plurality of elongated protruding ribs adjacent to the step.

12. The rechargeable energy storage system according to claim 11, wherein the plurality of battery cells are supported on top of the lower flange of one of the beam assemblies and on top of the step of an adjacent one of the plurality of elongated protruding ribs.

13. The rechargeable energy storage system according to claim 12, wherein the tray includes a bent side flange that is connected to the sidewall.

14. The rechargeable energy storage system according to claim 1, wherein each of the first face plate and the second face plate include an inlet coolant connector and an outlet coolant connector in communication with each of the pair of coolant passage plates.

15. The rechargeable energy storage system according to claim 14, wherein the pair of coolant passage plates include a serpentine coolant passage that extends from the inlet coolant connector to the outlet coolant connector.

16. The rechargeable energy storage system according to claim 14, wherein the inlet coolant connectors and the outlet coolant connectors of each beam assembly are connected to a coolant source.

17. The rechargeable energy storage system according to claim 1, wherein the first face plate includes a top cap including a first horizontal portion extending generally perpendicular to an outboard side of an upper end of the elongated face body, a vertically extending portion extending from the first horizontal portion and the upper flange of the first face plate extends horizontally from a top of the vertically extending portion.

18. A rechargeable energy storage system comprising:
a housing including a plurality of trays;
a plurality of beam assemblies extending in parallel across the housing, the plurality of beam assemblies each including a first face plate and a second face plate, the first face plate includes an elongated body having an upper flange extending generally perpendicular to an upper end of the elongated face body, the second face plate includes an elongated body having a lower flange extending generally perpendicular to a lower end of the elongated face body, a pair of coolant plates are sandwiched between the first face plate and the second face plate, wherein the pair of coolant plates are connected to a coolant source;
a plurality of battery cells disposed in the housing and in contact with the plates of adjacent beam assemblies; and
a first end beam assembly on one of the plurality trays and a second end beam assembly on an adjacent one of the plurality of trays, the first end beam being interconnected to the second end beam assembly, wherein the first and second end beam assemblies each include a first face plate and a second face plate joined to the first face plate and a coolant plate disposed between the first face plate and the second face plate.

19. The rechargeable energy storage system according to claim 18, wherein the first end beam includes a protruding top cap and the second end beam includes a protruding top cap that is connected to the protruding top cap of the firs tend beam.

20. A rechargeable energy storage system comprising:
a housing including a plurality of trays;
a plurality of beam assemblies extending in parallel across the housing, the plurality of beam assemblies each including a first face plate and a second face plate, the first face plate includes an elongated body having an upper flange extending generally perpendicular to an upper end of the elongated face body, the second face plate includes an elongated body having a lower flange extending generally perpendicular to a lower end of the elongated face body, a pair of coolant plates are sandwiched between the first face plate and the second face plate, wherein the pair of coolant plates are connected to a coolant source;
a plurality of battery cells disposed in the housing and in contact with the plates of adjacent beam assemblies; and
an end beam assembly disposed between adjacent ones of the plurality of trays, the end beam assembly including a sheet metal structure having a box shaped cross-section, a pair of face plates are secured to opposite sides of the sheet metal structure and a pair of coolant plates are disposed on an inboard face of the pair of face plates.
